(19) United States
(12) Patent Application Publication
(10) Pub. No.: US 2026/0134622 A1
(43) Pub. Date: May 14, 2026

(54) ENCODING AND DECODING POINT DATA IDENTIFYING A PLURALITY OF POINTS IN A THREE-DIMENSIONAL SPACE

(71) Applicant: Telefonaktiebolaget LM Ericsson (publ), Stockholm (SE)

(72) Inventor: Niclas SVENSSON, Stockholm (SE)

(73) Assignee: Telefonaktiebolaget LM Ericsson (publ), Stockholm (SE)

(21) Appl. No.: 19/121,416

(22) PCT Filed: Oct. 16, 2023
(86) PCT No.: PCT/EP2023/078709

§ 371 Date: Apr. 15, 2025

Related U.S. Application Data
(60) Provisional application No. 63/416,629, filed on Oct. 17, 2022.

(51) Int. Cl. G06T 17/10; G06T 9/20

(52) U.S. Cl. CPC G06T 17/10; G06T 9/20; G06T 2210/21; G06T 2210/56

(57) ABSTRACT

There is provided a method comprising obtaining three-dimension (3D) point data indicating a set of 3D points, determining a volume containing the set of 3D points, and partitioning the volume into a plurality of slices. The plurality of slices includes a first slice. The method further comprises partitioning the first slice into a plurality of sub-slices such that a dimension value of each of the sub-slices is equal to an integer multiple of a size of a node, partitioning each of the sub-slices into a plurality of nodes, and for each node, generating 3D point data indicating one or more 3D points included in the node.

### TECHNICAL FIELD

Disclosed are embodiments related to encoding and/or decoding point data identifying a plurality of points in a three-dimensional (3D) space (3D points) corresponding to a plurality of real-world points.

### BACKGROUND

Today 3D reconstruction of a space is widely used in various fields. For example, for home renovation, one or more cameras capable of capturing a 360-degree view may be used to capture multiple shots of a kitchen that is to be renovated, and the kitchen may be reconstructed in a 3D virtual space using the captured multiple images. The generated 3D reconstruction of the kitchen can be displayed on a screen and manipulated by a user in order to help the user to visualize how to renovate the kitchen. In 3D virtual space, there are a plurality of 3D points identifying an object or a structure of the 3D virtual space. In this disclosure, the plurality of 3D points is also referred as a 3D point cloud.

A 3D point cloud is an unstructured set of coordinates of points in a 3D space, and is typically used to capture the geometry and the scale of a scene (i.e., to represent 3D structures from the physical world). In addition to storing the set of point coordinates in a 3D space, a 3D point cloud can store additional information about the 3D points. This additional information is also called attributes. Typical attributes are color information, reflectance, normal vectors, etc.

Even though the embodiments of this disclosure are applicable to point clouds with attributes, for the purpose of simple explanation, the embodiments are explained in the light of geometry compression (i.e., compressing a set of 3D points Ω=(Xₖ, Yₖ, Zₖ)ₖ₌₁^{K}, where K is the number of points).

Typical point clouds range in size from a few kB to several GBs, which puts at stress any application requiring storage and/or transmission of such point clouds. Therefore, efficient point cloud compression solution is needed in all industrial applications relying on such point clouds.

Geometry based Point Cloud Compression (G-PCC) is the current Moving Picture Expert Group (MPEG) standard that targets the use case of static point clouds, as disclosed in Reference 1 cited at the end of this disclosure. It uses octree coding to compress the geometry of 3D points.

As shown in FIG. 15A, a coordinate of each 3D point included in the point clouds is quantized into an integer coordinate, and placed within a volume 1502 (e.g., a cube) having the dimension of D×D×D. The volume may be segmented into 8 sub-cubes 1512 having the dimension of D/2×D/2×D/2.

If a sub-cube 1512 contains at least one 3D point, then sub-cube 1512 is segmented into 8 smaller sub-cubes 1522 having the dimension of D/4×D/4×D/4. Then if smaller sub-cube 1522 contains at least one 3D point, then smaller sub-cube 1522 may be segmented into 8 micro sub-cubes 1532. This segmentation process can be repeated until a sub-cube of a predetermined size (e.g., D/16×D/16×D/16) containing the 3D point can be identified. On the other hand, if a sub-cube does not contain any 3D points, the segmentation process for this sub-cube branch may end.

The above process generates a tree structure (an octree) (shown in FIG. 15B) where each node can be represented using 8 bits and each bit indicates the occupancy status of one sub-cube. For example, the 8 bits 00010000 may indicate that a fourth sub-cube 1512 contains a 3D point data, and the 8 bits 00000011 may indicate that each of seventh and eighth smaller sub-cubes 1522 contains a 3D point.

For lossy compression, an octree is coded as a pre-determined level and the corresponding sequence of 8-bit words is entropy coded.

G-PCC also contains a module called trisoup which is explained in Reference 1. Similar to octree G-PCC, this compression method (a.k.a., trisoup coding) uses the octree coding to partition a point cloud into blocks (a.k.a., slices). Also, to ensure that a number of 3D points included in each slice does not exceed a threshold number of points (Nₜₕ, set to 1100000 in G-PCC CTC), these uniform cubic slices may be further split.

### SUMMARY

However, certain challenges presently exist in the trisoup coding. In the current MPEG G-PCC Common Test Conditions (CTC), uniform square partitioning of a point cloud into partitions is performed before the octree partitioning is performed. In the uniform square partitioning, the point cloud is split into uniform squares, thereby forming one or more cubes, where the side(s) of the cube(s) are determined by the smallest side of the bounding box of the point cloud. These partitions are called slices. A point cloud Ωpartitioned into M slices can therefore be described as

$$Ω = {⋃}_{i = 0}^{M - 1} {Ω}_{i} ,$$

where Ωᵢ represents the set of points in a specific slice.

To ensure that no more than a certain threshold number of points (Nₜₕ, set to 1100000 in G-PCC CTC) is included in each slice, these uniform cubic slices are further split into slices (in this disclosure, also called as sub-slices). However, a dimension of each of the sub-slices may not be equal to a multiple of the nodeSize. This implies that boundaries between two adjacent slices do not necessarily align with boundaries between two adjacent trisoup nodes. This misalignment may result in incorrect encoding and/or decoding of 3D point data indicating 3D points in each trisoup node, as explained below in more detail with respect to FIGS. 9A, 9B, and 10A.

Accordingly, in one aspect of the embodiments of this disclosure, there is provided a method comprising obtaining three-dimension, 3D, point data indicating a set of 3D points, determining a volume containing the set of 3D points, and partitioning the volume into a plurality of slices, wherein the plurality of slices includes a first slice. The method further comprises partitioning the first slice into a plurality of sub-slices such that a dimension value of each of the sub-slices is equal to an integer multiple of a size of a node, partitioning each of the sub-slices into a plurality of nodes, and for each node, generating 3D point data indicating one or more 3D points included in the node.

In another aspect, there is provided a computer program comprising instructions which when executed by processing circuitry cause the processing circuitry to perform the method of any one of embodiments described above.

In another aspect, there is provided a carrier containing the computer program of the embodiment descried above, wherein the carrier is one of an electronic signal, an optical signal, a radio signal, and a computer readable storage medium.

In another aspect, there is provided an apparatus being configured to obtain three-dimension, 3D, point data indicating a set of 3D points, determine a volume containing the set of 3D points, and partition the volume into a plurality of slices, wherein the plurality of slices includes a first slice. The apparatus is further configured to partition the first slice into a plurality of sub-slices such that a dimension value of each of the sub-slices is equal to an integer multiple of a size of a node, partition each of the sub-slices into a plurality of nodes, and for each node, generate 3D point data indicating one or more 3D points included in the node.

In another aspect, there is provided an apparatus comprising a processing circuitry; and a memory, said memory containing instructions executable by said processing circuitry, whereby the apparatus is operative to perform the method of any one of embodiments described above.

By ensuring that a dimension of each sub-slice is equal to an integer multiple of the size of a trisoup node, encoding and/or decoding of 3D point data can be improved. More explanation about the improvement is described below in more detail with FIGS. 7B, 8A, and 8B.

The accompanying drawings, which are incorporated herein and form part of the specification, illustrate various embodiments.

### BRIEF DESCRIPTION OF THE DRAWINGS

FIG. 1 shows a system according to some embodiments.

FIG. 2A shows an apparatus according to some embodiments.

FIG. 2B shows an example of a virtual reality scene.

FIG. 3 shows a process according to some embodiments.

FIG. 4A shows a bounding box surrounding a 3D point cloud.

FIGS. 4B, 5A, and 5B show a plurality of slices of a bounding box.

FIG. 6 shows a process according to some embodiments.

FIGS. 7A and 7B show a method of partitioning according to some embodiments.

FIG. 8A shows a method of encoding point data according to some embodiments.

FIG. 8B shows a method of decoding point data according to some embodiments.

FIGS. 9A, 9B, and 10A show a potential problem of partitioning in certain scenarios.

FIG. 10B shows a process according to some embodiments.

FIG. 11A shows a process according to some embodiments.

FIG. 11B shows a process according to some embodiments.

FIG. 12 shows a process according to some embodiments.

FIG. 13 shows a process according to some embodiments.

FIG. 14 shows an apparatus according to some embodiments.

FIG. 15A illustrates an octree coding method.

FIG. 15B illustrates an octree coding method.

### DETAILED DESCRIPTION

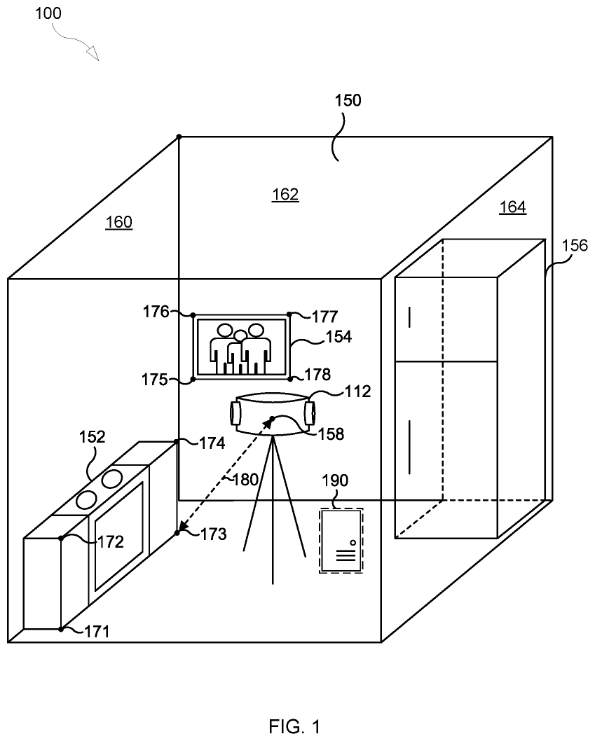

FIG. 1 shows an exemplary scenario 100 where embodiments of this disclosure are implemented. In scenario 100, a capturing device 112 is used to capture a view of a kitchen 150 at a location. In kitchen 150, an oven 152, a picture frame 154, and a refrigerator 156 are located. As shown in FIG. 1, oven 152 is placed against a first wall 160, picture frame 154 is placed against a second wall 162, and refrigerator 156 is placed against second wall 162 and a third wall 164.

Capturing device 112 includes a camera and a Light Detection and Ranging (LiDAR) sensor. The camera is configured to capture a view of kitchen 150. One example of the camera is a 360-degree camera—a camera that is capable of capturing a 360-degree view of a real-world environment.

The LiDAR sensor is configured to collect depth values of various real-world points (e.g., points 171-178) of kitchen 150. Here, a depth value of a particular real-world point indicates a distance between a view point 158 of capturing device 112 and the particular real-world point. For example, a depth value of a real-world point 173 indicates a distance 180 between point 173 and view point 158. One example of view point 158 is a center point of the camera.

Once the view of kitchen 150 is captured by the camera and depth values of the real-world points included in the view of kitchen 150 are measured by the LiDAR sensor, capturing device 112 may transmit the captured/measured data to a computing device 190 which is connected to capturing device 112 (wirelessly or via a wired connection). After receiving the data, computing device 190 may combine the data collected by the camera and the data collected by the LiDAR sensor, thereby generating 3D point data identifying a plurality of a three-dimensional (3D) points.

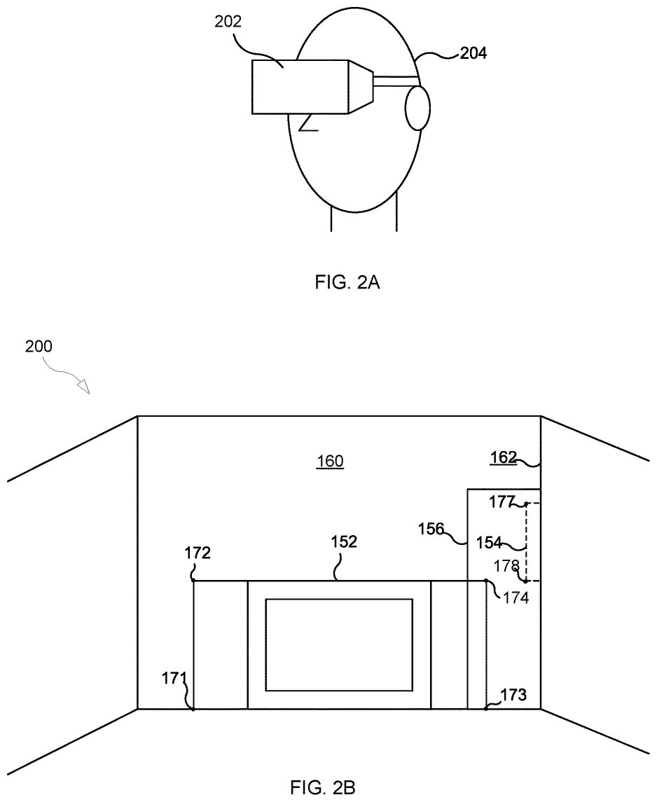

In some embodiments, the 3D point data identifying the 3D points may be used to reconstruct the real-world environment captured by capturing device 112. For example, the 3D point data identifying the 3D points may be used to generate an extended-reality (XR) (including a virtual-reality, a mixed-reality, or an augmented-reality) scene using an XR display 202 shown in FIG. 2A. View 200 shown in FIG. 2B is an example of the view user 204 sees via XR display 202. The 3D point data of each 3D point may include a 3D coordinate of the 3D point and/or attributes such as color/luminance values of the 3D point.

The 3D point data identifying the plurality of 3D points generated by computing device 190 may be stored in a storage (e.g., included in computing device 190). However, typical size of the 3D point data ranges from 1 GB to several GBs, and thus storing the 3D point data would require a substantial amount of storage space.

Additionally, in some scenarios, there is a need to send the point data of the 3D points from one entity to another entity. For example, assume that an owner of a house wants to renovate kitchen 150 but a desired kitchen designer is located far from the house. In such case, once a view of kitchen 150 is captured and the point data identifying the 3D points of kitchen 150 is generated by computing device 190, the point data needs to be sent from computing device 190 to XR display device 202 such that the kitchen designer can see the reconstructed 3D view of kitchen 150. However, due to the large size of point data, transmitting the 3D point data would consume a substantial amount of data bandwidth. Therefore, there is a need for efficiently compressing and decompressing the 3D point data identifying the plurality of 3D points.

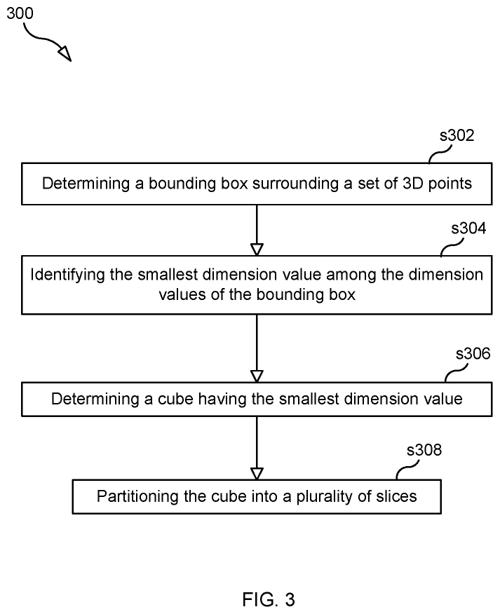

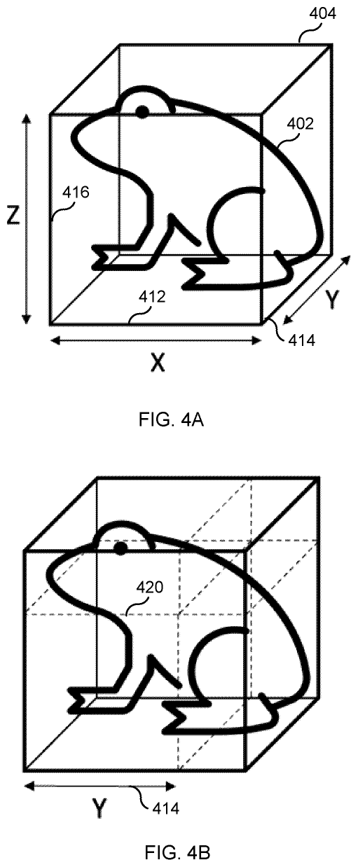

FIG. 3 shows a process 300 for compressing (i.e., encoding) 3D point data indicating a set of 3D points (a.k.a., a “3D point cloud”), according to some embodiments. Process 300 may begin with step s302. Step s302 comprises determining a bounding box that surrounds the set of 3D points. For example, in FIG. 4A, the set of 3D points forms the shape of a frog 402, and via step s302, a bounding box 404 surrounding frog 402 is obtained. As shown in FIG. 4A, bounding box 402 has a first dimension value 412 (e.g., the width in X direction), a second dimension value 414 (e.g., the depth in Y direction), and a third dimension value 416 (e.g., the height in Z direction).

After determining bounding box 404, process 300 may proceed to step s304. Step s304 comprises identifying the smallest dimension value among first, second, and third dimension values 412, 414, and 416. In the example shown in FIG. 4A, second dimension value 414 is the smallest.

After identifying the smallest dimension value, process 300 may proceed to step s306 which comprises determining a cube having the smallest dimension value. For example, since second dimension value 414 is the smallest, in step s306, as shown in FIG. 4B, a cube 420 (the bottom left box among the four boxes bounded by dotted lines) having second dimension value 414 is obtained.

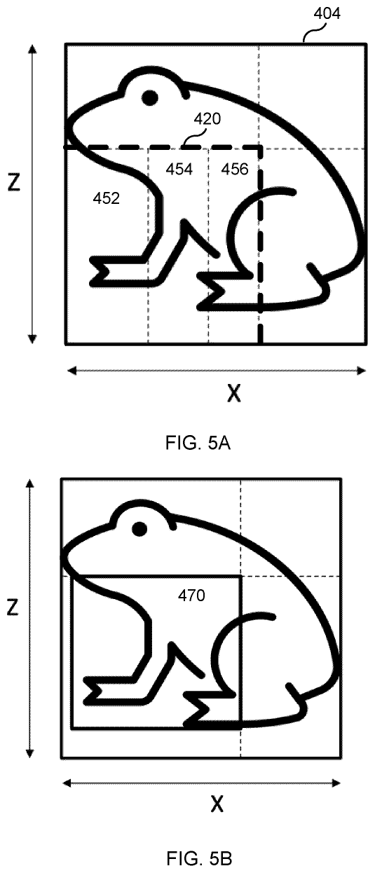

After determining cube 420, process 300 may proceed to step s308. Step s308 comprises partitioning cube 420 into a plurality of slices. For example, FIG. 5A shows the x-Z plane view of bounding box 404, and in FIG. 5A, cube 420 is partitioned into a plurality of slices 452, 454, and 456.

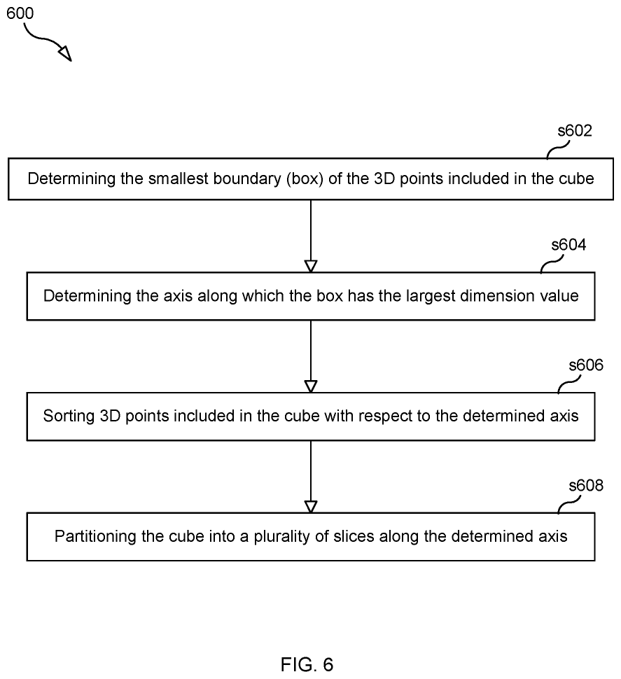

FIG. 6 shows a process 600 for partitioning cube 420 into a plurality of slices 452, 454, and 456 according to some embodiments. Process 600 may begin with step s602. Step s602 comprises determining the smallest boundary of the 3D points included in cube 420. For example, as shown in FIG. 5B, the smallest boundary of the 3D points (corresponding to the shape of frog 402) included in cube 420 is a box 470 (a rectangle in the x-z plane view) that is smaller than cube 420.

Then, in step s604, the axis along which box 420 has the largest dimension value is determined. For example, in FIG. 5B, the dimension value of box 470 along the x-axis (i.e., the width) is greater than the dimension value of box 470 along the z-axis (i.e., the height). Thus, in step s604, the x-axis is identified. The axis determined in step s604 corresponds a direction of partitioning cube 420 (i.e., thereby partitioning cube 420 into the plurality of slices 452, 454, and 456, which are arranged along the x-axis).

After determining the direction of partitioning cube 402 (a.k.a., slicing direction or split direction), step s606 may be performed. Step s606 comprises sorting the 3D points included in cube 402 along the x-axis. More specifically, the 3D points may be sorted such that they are arranged in the order of the 3D point having the smallest x coordinate to the 3D point having the largest x coordinate. For example, for simple explanation purpose, let's assume that there are three 3D points in cube 402—p1 (x1, y1, z1), p2 (x2, y2, z2), and p3 (x3, y3, x3), and x2>x1>x3. Then, via step s606, the 3D points will be sorted in the sequence of p3, p1, and p2.

Referring back to FIG. 6, after sorting the 3D points in step s606, step s608 may be performed. Step s608 comprises partitioning cube 420 into a plurality of slices along the axis determined in step s604 (i.e., the x-axis) such that a number of 3D points included in each of the slices is less than or equal to a threshold value. Here, the threshold value indicates the maximum number of 3D points that are allowed to be included in each slice. The threshold value may be a predefined value or may be set by a user.

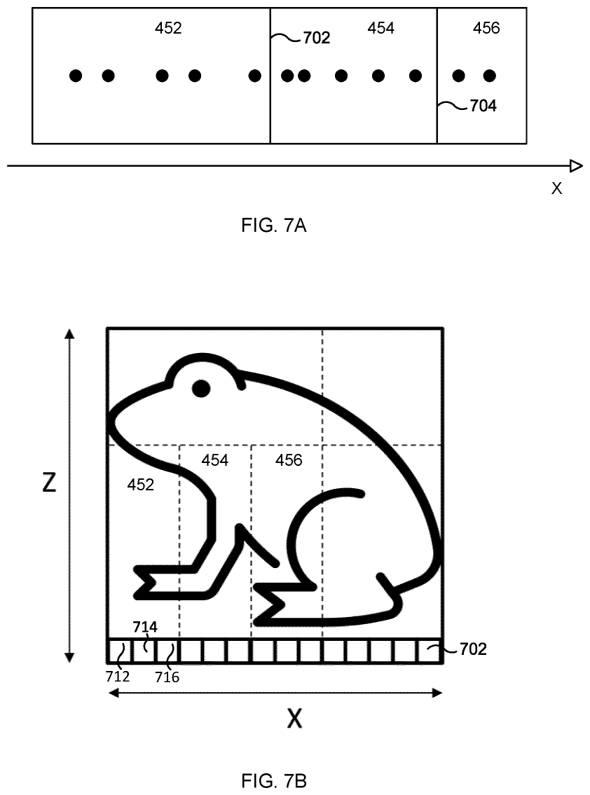

FIG. 7A shows a graphical representation of the sorted 3D points obtained in step s606. After obtaining the list of the sorted 3D points, first slice 452 that contains up to the maximum allowed number of 3D points is determined. For example, in case the threshold value is 5, a boundary 702 of first slice 452 is determined such that first slice 452 contains only up to five 3D points. Similarly, a boundary 704 of second slice 454 is determined such that second slice 454 contains only up five 3D points.

In case the dimension of each of first, second, and third slices 452, 454, and 456 is an integer multiple of the size of the trisoup node, as shown in FIG. 7B, each of the slices is encoded using one or more trisoup nodes. For example, FIG. 7B shows that three trisoup nodes 712, 714, and 716 are included in first slice 452, and the 3D points included in each of trisoup nodes 702, 704, and 706 may be grouped and encoded together.

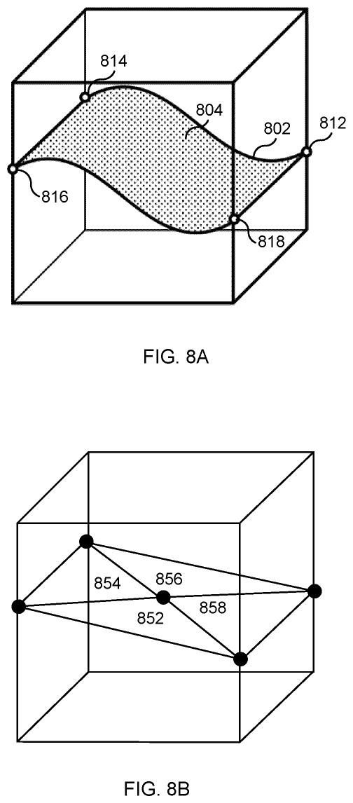

FIG. 8A illustrates how 3D points included in a trisoup node can be encoded together. As shown in FIG. 8A, first, a point surface 802 on which 3D points 804 (the very small dots included in surface 802) are located is determined. Point surface 802 may be a curved surface or a flat surface (depending on the distribution of the 3D points). Once point surface 802 is determined, cross points 812, 814, 816, and 818 at which point surface 802 crosses the boundary of the trisoup node are determined. Additionally, a center point 830 of point surface 802 may be determined.

After determining cross points 812, 814, 816, and 818 and center point 830 of point surface 802, data corresponding to cross points 812, 814, 816, and 820, and center point 830 is generated and transmitted to a decoding entity. Upon receiving the data, the decoding entity may be configured to reconstruct point surface 802 using the data, and reconstruct the 3D points of the trisoup node using the reconstructed surface.

One way of reconstructing point surface 802 at the decoding entity is illustrated in FIG. 8B. As shown in FIG. 8B, point surface 802 may be reconstructed by finding a plurality of triangle areas 852, 854, 856, and 858 using the cross points and the center point. For example, triangle area 852 is formed by cross points 816 and 818, and center point 830, triangle area 854 is formed by cross points 814 and 816, and center point 830, triangle area 856 is formed by cross points 812 and 814, and center point 830, and triangle area 858 is formed by cross points 812 and 818, and center point 830.

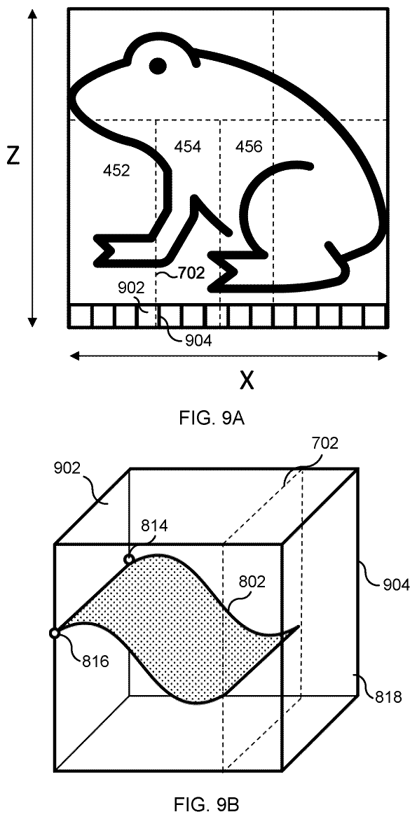

As mentioned above, the above described method of encoding the 3D point data using trisoup nodes (i.e., trisoup coding) is based on the assumption that the dimension of each of first, second, and third slices 452, 454, and 456 is equal to an integer multiple of the size of the trisoup node, as shown in FIG. 7B. However, as shown in FIG. 9A, in some scenarios, the dimension of each of first, second, and third slices 452, 454, and 456 may not be equal to an integer multiple of the size of the trisoup node. In other words, as shown in FIG. 9A, a boundary 702 between first slice 452 and second slice 454 may not align with a boundary 904 of a trisoup node 902.

Such misalignment is problematic because it may result in incorrect encoding and/or decoding. For example, as explained with respect to FIG. 8A, encoding of the 3D points included in each trisoup node is based on finding cross points (e.g., 812, 814, 816 and/or 818) at which a point surface (e.g., 802) crosses with the boundary of the trisoup node. But if boundary 702 of first slice 452 is before boundary 904 of trisoup node 902, as shown in FIG. 9B, there won't be any cross points at which point surface 802 crosses boundary 904. Thus, the encoded data for the 3D points in trisoup node 902 would only contain 3D point data indicating 3D points 814 and 816 (and center point 830 of trisoup node 902) but would not contain 3D point data indicating 3D points 812 and 816 shown in FIG. 8A.

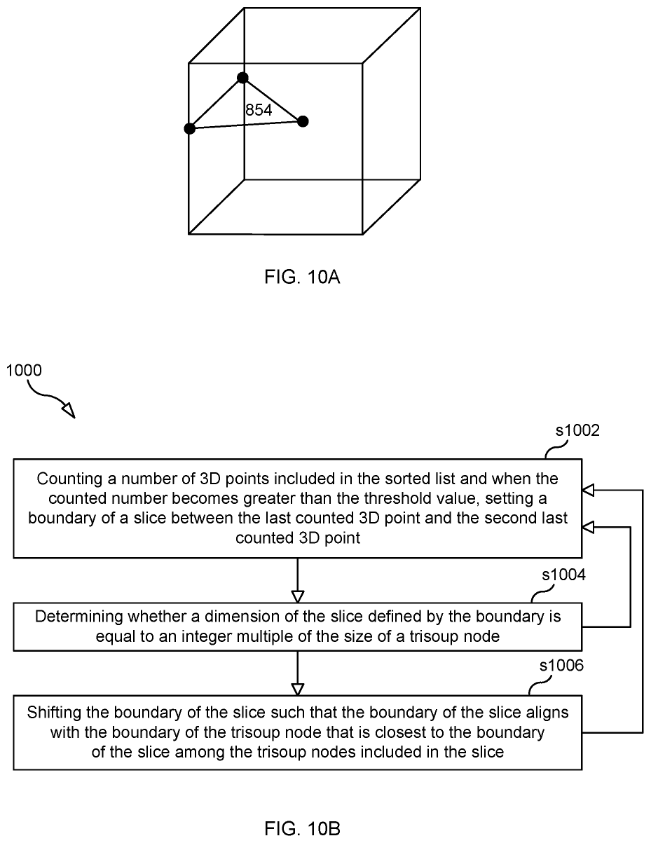

If the decoding entity receives such encoded data, the decoding entity would reconstruct point surface 802 using only tringle area 854 (as shown in FIG. 10A) instead of multiple triangle areas 852, 854, 956, and 858 (as shown in FIG. 8B), thereby resulting in an incorrect reconstruction of the 3D points included in trisoup node 902.

Thus, according to some embodiments, cube 420 is partitioned into slices 452, 454, and 456 such that a dimension of each slice 452, 454, and 456 is equal to an integer multiple of the size of a trisoup node 702, as shown in FIG. 7B. For example, in FIG. 7B, the width of each of slices 452, 454, and 456 is equal to three times of the width of trisoup node 702.

In order to set the dimension of each slice to be equal to an integer multiple of the size of a trisoup node 702, process 1000 shown in FIG. 10B may be performed during step s608—the step for partitioning cube 420 into a plurality of slices along the determined axis. Process 1000 may begin with step s1002.

Step s1002 comprises counting a number of 3D points included in the sorted list of 3D points and when the counted number becomes greater than the threshold value, setting a boundary of a slice between the last counted 3D point and the second last counted 3D point such that the total number of 3D points is equal to the threshold value.

For example, let's assume that the sorted list of 3D points includes twenty seven 3D points—{P₁, P₂, P₃, P₄, P₅, P₆, P₇, P₈, P₉, P₁₀, . . . , P₂₇} and the threshold value is equal to 8. Then, in step s1002, when the counted number is equal to 9 (which is greater than the threshold value), the boundary of a slice is set between the last counted 3D point P₉ and the second last counted 3D point P₈. Then process 1000 may proceed to step s1004.

Step s1004 comprises determining whether a dimension of the slice defined by the boundary set in step s1002 is equal to an integer multiple of the size of a trisoup node. If the dimension of the slice is equal to an integer multiple of the size of a trisoup node, then process 1000 may return back to step s1002, and step s1002 is performed on the 3D points that are not included in the slice—{P₉, P₁₀, P₁₁, P₁₂, P₁₃, . . . , P₂₇}. On the other hand, if the dimension of the slice is not equal to an integer multiple of the size of a trisoup node, then process 1000 may proceed to step s1006. Step s1006 comprises shifting the boundary of the slice set in step s1002 such that the boundary of the slice aligns with the boundary of the trisoup node that is closest to the boundary of the slice within the slice.

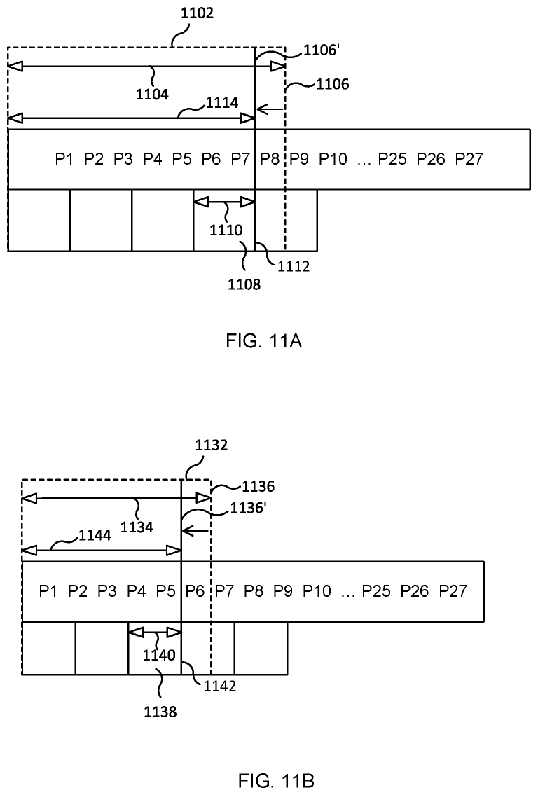

For example, as shown in FIG. 11A, in case a dimension 1104 of a slice 1102 defined by boundary 1106 formed between P₈ and P₉ is not equal to an integer multiple of size 1110 of a trisoup node 1108, in step s1006, boundary 1106 is shifted such that shifted boundary 1106′ aligns with boundary 1112 of trisoup node 1108 which is closest to boundary 1106 of slice 1102 among trisoup nodes included slice 1102. By shifting boundary 1106, a dimension 1114 of the slice defined by the shifted boundary 1106′ is equal to an integer multiple of size 1110 of trisoup node 1108.

After performing step s1006, process 1000 may return back to step s1002, and step s1002 is performed on the 3D points that are not included in the slice—{P₈, P₉, P₁₀, P₁₁, P₁₂, . . . , P₂₇}. Steps s1002-s1006 may be performed repeatedly until there is no 3D points that were not counted in step s1002.

The partitioning process 1000 shown in FIG. 10 renders the maximum number of 3D points to be included in each slice while satisfying the two conditions: (1) that the number of 3D points included in each slice is less than or equal to the threshold value and (2) that a dimension of each slice is equal to an integer multiple of a size of a trisoup node. However, including the maximum number of 3D points (which satisfying the two conditions) in each slice may not be the best option in some scenarios.

For example, there may be a scenario where including a reduced number of 3D points in each slice is desirable. More specifically, there may be a scenario where it is desirable to have a reduced number of 3D points in each slice such that a distribution of 3D points in each slice is more dense (which may result in improving the quality of encoding).

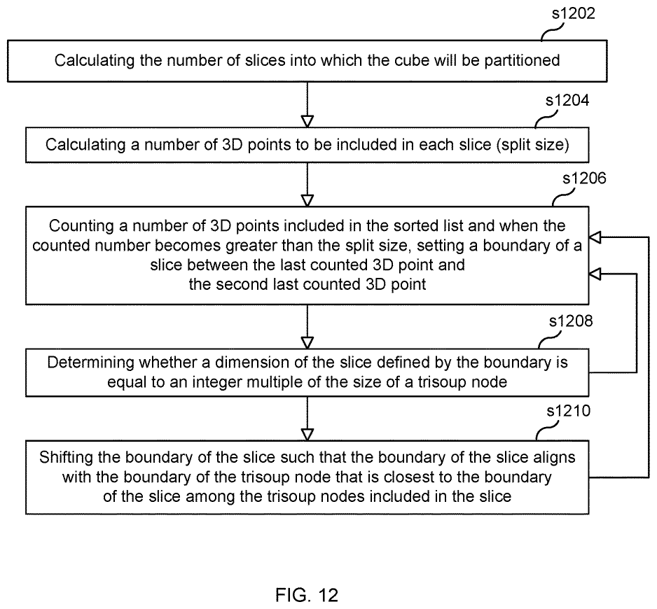

In such scenario, according to some embodiments, process 1200 shown in FIG. 12 may be performed instead of process 1000 shown in FIG. 10B for the partitioning. Process 1200 may begin with step s1202.

Step s1202 comprises calculating the number of slices (a.k.a., splits) (S_{N}) into which cube 420 will be partitioned based on i) the total number of 3D points included in cube 420 and ii) the threshold value Nₜₕ. As mentioned above, this threshold value may be predefined or may be set by a user. In some embodiments, S_{N}=┌N/Nₜₕ┐. For example, in case the total number of 3D points included in cube 420 (N) is 27 and the threshold value (Nₜₕ) is 8, then the number of slices calculated in step s1202 would be S_{N}=┌27/8┐=4. In other embodiments, the number of slices may be equal to S_{N}=┌N/Nₜₕ┐+1 instead. This would certainly ensure that the last slice being partitioned would represent a volume that does not exceeds Nₜₕ points. This would, however, have the consequence that the last slice is likely to be very thin and therefore would be inefficiently compressed by the existing framework.

After calculating the number of slices in step s1202, step s1204 may be performed. Step s1204 comprises calculating a number of 3D points to be included in each slice. In this disclosure, the number of 3D points to be included in each slice may also be referred as “split size.” In some embodiments, the split size is equal to S_{size}=└N/S_{N}┘. Thus, in the above example, the split size (the number of 3D points included in each slice) (S_{size}) calculated in step s1204 would be └27/4┘=6. After performing step s1204, step s1206 may be performed.

In some embodiments, the split size calculated above (e.g., S_{size}=└N/S_{N}┘) may be set as an initial split size, and the final split size to be used in the remaining steps of process 1200 may be obtained by refining the initial split size. For example, in case the initial split size is equal to S_{size_initial}=└N/S_{N}┘, the final split size may be equal to S_{size}=(S_{size_initial}+Nₜₕ)/2. According to these embodiments, in the example provided above, the final split size would be (6+8)/2=7. Alternatively, the split size to be used in the remaining steps of process 1200 may be obtained directly by calculating

$${S}_{size} = ( ⌊ \frac{N}{{S}_{N}} ⌋ + {N}_{th} ) / 2.$$

Step s1206 comprises counting a number of 3D points included in the sorted list of 3D points and when the counted number becomes greater than the split size, setting a boundary of a slice between the last counted 3D point and the second last counted 3D point.

For example, let's assume that the sorted list of 3D points includes twenty seven 3D points—{P₁, P₂, P₃, P₄, P₅, P₆, P₇, P₈, P₉, P₁₀, . . . , P₂₇} and the split size is equal to 6. Then, in step s1206, when the counted number is equal to 7 (which is greater than the split size), the boundary of a slice is set between the last counted 3D point P₇ and the second last counted 3D point P₆. Then process 1200 may proceed to step s1208.

Step s1208 comprises determining whether a dimension of the slice defined by the boundary set in step s1206 is equal to an integer multiple of the size of a trisoup node. If the dimension of the slice is equal to an integer multiple of the size of a trisoup node, then process 1200 may return back to step s1206, and step s1206 is performed on the 3D points that are not included in the slice—{P₇, P₈, P₉, P₁₀, . . . , P₂₇}. On the other hand, if the dimension of the slice is not equal to an integer multiple of the size of a trisoup node, then process 1200 may proceed to step s1210. Step s1210 comprises shifting the boundary of the slice set in step s1206 such that the boundary of the slice aligns with the boundary of the trisoup node that is closest to the boundary of the slice within the slice.

For example, as shown in FIG. 11B, in case a dimension 1134 of a slice 1132 defined by boundary 1136 formed between P₆ and P₇ is not equal to an integer multiple of size 1140 of a trisoup node 1138, in step s1210, boundary 1136 is shifted such that shifted boundary 1136′ aligns with boundary 1142 of trisoup node 1138 which is closest to boundary 1136 of slice 1132 among trisoup nodes included slice 1132. By shifting boundary 1136, a dimension 1144 of the slice defined by the shifted boundary 1136′ is equal to an integer multiple of size 1140 of trisoup node 1108.

After performing step s1210, process 1200 may return back to step s1206, and step S1206 is performed on the 3D points that are not included in the slice—{P₆, P₇, P₈, P₉, P₁₀, . . . , P₂₇}. Steps s1206-s1210 may be performed repeatedly until there is no 3D points that were not counted in step s1206.

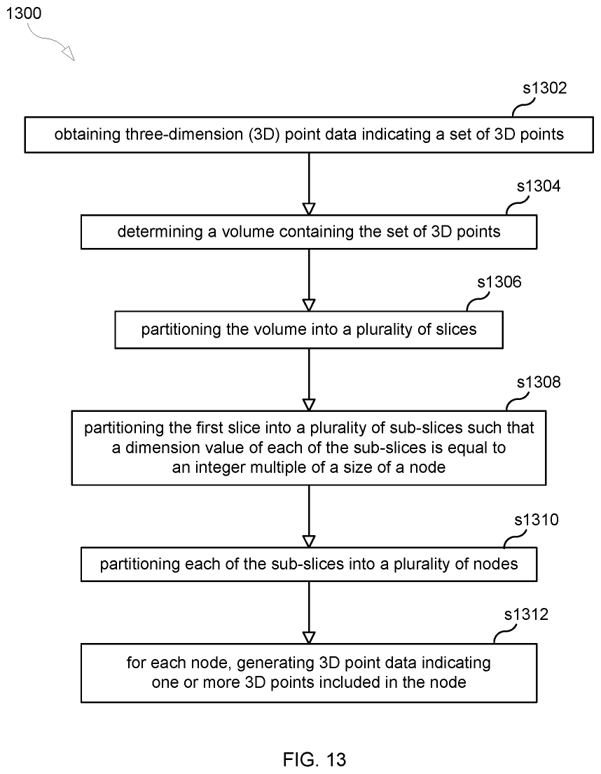

FIG. 13 shows a process 1300 according to some embodiments. Process 1300 may begin with step s1302. Step s1302 comprises obtaining three-dimension, 3D, point data indicating a set of 3D points. Step s1304 comprises determining a volume (e.g., left FIG. 3, the cube) containing the set of 3D points. Step s1306 comprises partitioning the volume into a plurality of slices (e.g., right FIG. 3, the three boxes bounded by dotted lines and the cube at the bottom left), wherein the plurality of slices includes a first slice (e.g., right FIG. 3, the cube at the bottom left). Step s1308 comprises partitioning the first slice into a plurality of sub-slices (FIG. 8, the bottom left three rectangles bounded by the dotted lines) such that a dimension value of each of the sub-slices is equal to an integer multiple of a size of a node. Step s1310 comprises partitioning each of the sub-slices into a plurality of nodes. Step s1312 comprises, for each node, generating 3D point data indicating one or more 3D points included in the node.

In some embodiments, each of the nodes is a trisoup node.

In some embodiments, generating the 3D point data indicating said one or more 3D points included in the node comprises: finding within the node a point surface (e.g., left FIG. 7, the curved surface) on which said one or more 3D points are located: identifying one or more crossing points at which the point surface crosses edges of the node; and generating cross point data indicating the identified one or more crossing points.

In some embodiments, process 1300 comprises determining a boundary (e.g., 1106 in FIG. 11A or 1136 in FIG. 11B) of a first initial sub-slice (e.g., 1102 in FIG. 11A or 1132 in FIG. 11B) of the first slice, wherein a dimension value of the first initial sub-slice is not equal to an integer multiple of the size of the node; and in case the dimension value of the first initial sub-slice is not equal to an integer multiple of the size of the node, adjusting the boundary of the first initial sub-slice such that the dimension value of the first initial sub-slice is equal to an integer multiple of the size of the node, wherein a boundary of one of the plurality of sub-slices is equal to the adjusted boundary (e.g., 1106′ in FIG. 11A or 1136′ in FIG. 11B) of the first initial sub-slice.

In some embodiments, adjusting the boundary of the first initial sub-slice results in reducing the dimension value of the first initial sub-slice.

In some embodiments, process 1300 comprises calculating a number of a plurality of initial sub-slices of the first slice based on a number of 3D points included in the first slice and a threshold value; and calculating a number of 3D points included in each of the initial sub-slices (N_{size}) based on the number of 3D points included in the first slice and the calculated number of initial sub-slices, wherein the number of 3D points included in each of the initial sub-slices is less than or equal to the threshold value, and the plurality of initial sub-slices includes the first initial sub-slice.

In some embodiments, process 1300 comprises counting a number of 3D points (e.g., six) arranged in a particular direction within the first slice (e.g., 1132 in FIG. 11B); and stopping the counting when the counted number becomes greater than N_{size}, wherein the boundary (e.g., 1136 in FIG. 11B) of the first initial sub-slice (e.g., 1132 in FIG. 11B) is determined such that the boundary of the first initial sub-slice is between a location of the last counted 3D point (e.g., P7) and the second last counted 3D point (e.g., P6).

In some embodiments, S_{N}=┌N/Nₜₕ┐, where S_{N} is the number of initial sub-slices, N is the number of 3D points included in the first slice, and Nₜₕ is the threshold value.

In some embodiments, S_{size}=└N/S_{N}┘, where S_{size} is the number of 3D points included in each of the initial sub-slices, N is the number of 3D points included in the first slice, and S_{N} is the number of initial sub-slices.

In some embodiments,

$${S}_{size} = ( ⌊ \frac{N}{{S}_{N}} ⌋ + {N}_{th} ) / 2 ,$$

where S_{size} is the number of 3D points included in each of the initial sub-slices, N is the number of 3D points included in the first slice, S_{N} is the number of initial sub-slices, and Nₜₕ is the threshold value.

In some embodiments, process 1300 comprises determining within the first slice a bounding box bounding all 3D points included in the first slice, wherein the bounding box has a first dimension value associated with a first direction, a second dimension value associated with a second direction, and a third dimension value associated with a third direction, and further wherein the first dimension value is greater than the second dimension value and/or the third dimension value; and sorting 3D points included the first slice in the first direction such that the 3D points included in the first slice are sequentially arranged with respect to the first direction.

In some embodiments, process 1300 comprises dividing the sequentially arranged 3D points into a plurality of groups of sequentially arranged 3D points; and assigning each group of sequentially arranged 3D points into the initial sub-slices.

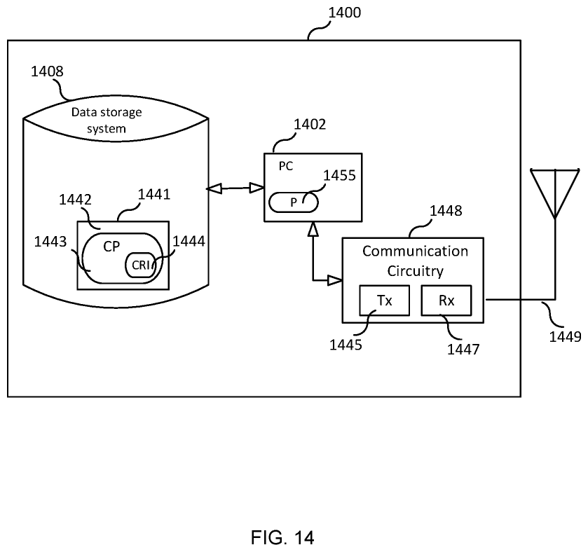

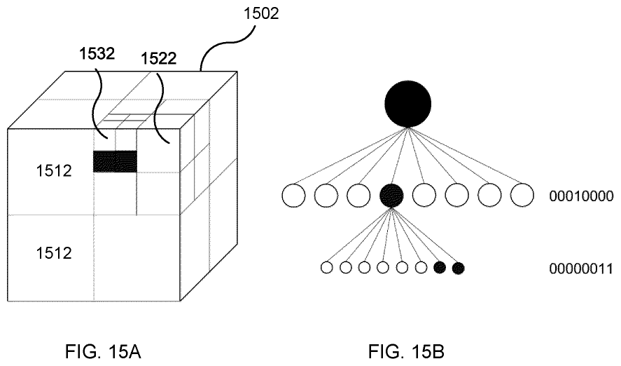

FIG. 14 is a block diagram of an apparatus 1400 for implementing an encoder, a decoder, or a component included in the encoder or the decoder, according to some embodiments. When apparatus 1400 implements a decoder, apparatus 1400 may be referred to as a “decoding apparatus 1400,” and when apparatus 1400 implements an encoder, apparatus 1400 may be referred to as an “encoding apparatus 1400.” As shown in FIG. 14, apparatus 1400 may comprise: processing circuitry (PC) 1402, which may include one or more processors (P) 1455 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1400 may be a distributed computing apparatus): at least one network interface 1448 comprising a transmitter (Tx) 1445 and a receiver (Rx) 1447 for enabling apparatus 1400 to transmit data to and receive data from other nodes connected to a network 110 (e.g., an Internet Protocol (IP) network) to which network interface 1448 is connected (directly or indirectly) (e.g., network interface 1448 may be wirelessly connected to the network 110, in which case network interface 1448 is connected to an antenna arrangement); and a storage unit (a.k.a., “data storage system”) 1408, which may include one or more non-volatile storage devices and/or one or more volatile storage devices. In embodiments where PC 1402 includes a programmable processor, a computer program product (CPP) 1441 may be provided. CPP 1441 includes a computer readable medium (CRM) 1442 storing a computer program (CP) 1443 comprising computer readable instructions (CRI) 1444. CRM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes apparatus 1400 to perform steps described herein (e.g., steps described herein with reference to the flow charts). In other embodiments, apparatus 1400 may be configured to perform steps described herein without the need for code. That is, for example, PC 1402 may consist merely of one or more ASICs. Hence, the features of the embodiments described herein may be implemented in hardware and/or software.

### Summary of Embodiments

A1. A method (1300) comprising:
obtaining (s1302) three-dimension, 3D, point data indicating a set of 3D points:
determining (s1304) a volume (e.g., left FIG. 3, the cube) containing the set of 3D points;
partitioning (s1306) the volume into a plurality of slices (e.g., right FIG. 3, the three boxes bounded by dotted lines and the cube at the bottom left), wherein the plurality of slices includes a first slice (e.g., right FIG. 3, the cube at the bottom left);
partitioning (s1308) the first slice into a plurality of sub-slices (FIG. 8, the bottom left three rectangles bounded by the dotted lines) such that a dimension value of each of the sub-slices is equal to an integer multiple of a size of a node;
partitioning (s1310) each of the sub-slices into a plurality of nodes; and
for each node, generating (s1312) 3D point data indicating one or more 3D points included in the node.

A2. The method of embodiment A1, wherein each of the nodes is a trisoup node.

A3. The method of embodiment A1 or A2, wherein generating the 3D point data indicating said one or more 3D points included in the node comprises:
finding within the node a point surface (e.g., left FIG. 7, the curved surface) on which said one or more 3D points are located;
identifying one or more crossing points at which the point surface crosses edges of the node; and
generating cross point data indicating the identified one or more crossing points.

A4. The method of at least one of embodiments A1-A3, comprising:
determining a boundary (e.g., 1106 in FIG. 11A or 1136 in FIG. 11B) of a first initial sub-slice (e.g., 1102 in FIG. 11A or 1132 in FIG. 11B) of the first slice, wherein a dimension value of the first initial sub-slice is not equal to an integer multiple of the size of the node; and
in case the dimension value of the first initial sub-slice is not equal to an integer multiple of the size of the node, adjusting the boundary of the first initial sub-slice such that the dimension value of the first initial sub-slice is equal to an integer multiple of the size of the node, wherein
a boundary of one of the plurality of sub-slices is equal to the adjusted boundary (e.g., 1106′ in FIG. 11A or 1136′ in FIG. 11B) of the first initial sub-slice.

A5. The method of embodiment A4, wherein adjusting the boundary of the first initial sub-slice results in reducing the dimension value of the first initial sub-slice.

A6. The method of at least one of embodiments A4-A5, comprising:
calculating a number of a plurality of initial sub-slices of the first slice based on a number of 3D points included in the first slice and a threshold value; and
calculating a number of 3D points included in each of the initial sub-slices (N_{size}) based on the number of 3D points included in the first slice and the calculated number of initial sub-slices, wherein
the number of 3D points included in each of the initial sub-slices is less than or equal to the threshold value, and
the plurality of initial sub-slices includes the first initial sub-slice.

A7. The method of embodiment A6, comprising:
counting a number of 3D points (e.g., six) arranged in a particular direction within the first slice (e.g., 1132 in FIG. 11B); and
stopping the counting when the counted number becomes greater than N_{size}, wherein the boundary (e.g., 1136 in FIG. 11B) of the first initial sub-slice (e.g., 1132 in FIG. 11B) is determined such that the boundary of the first initial sub-slice is between a location of the last counted 3D point (e.g., P7) and the second last counted 3D point (e.g., P6).

A8. The method of embodiment A7, wherein S_{N}=┌N/Nₜₕ┐, where S_{N} is the number of initial sub-slices, N is the number of 3D points included in the first slice, and Nₜₕ is the threshold value.

A9. The method of embodiment A7 or A8, wherein S_{size}=└N/S_{N}┘, where S_{size} is the number of 3D points included in each of the initial sub-slices, N is the number of 3D points included in the first slice, and S_{N} is the number of initial sub-slices.

A9a. The method of embodiment A7 or A8, wherein

$${S}_{size} = ( ⌊ \frac{N}{{S}_{N}} ⌋ + {N}_{th} ) / 2 ,$$

where S_{size} is the number of 3D points included in each of the initial sub-slices, N is the number of 3D points included in the first slice, S_{N} is the number of initial sub-slices, and Nₜₕ is the threshold value.

A10. The method of at least one of embodiments A1-A9a, comprising:
determining within the first slice a bounding box bounding all 3D points included in the first slice, wherein the bounding box has a first dimension value associated with a first direction, a second dimension value associated with a second direction, and a third dimension value associated with a third direction, and further wherein the first dimension value is greater than the second dimension value and/or the third dimension value; and
sorting 3D points included the first slice in the first direction such that the 3D points included in the first slice are sequentially arranged with respect to the first direction.

A11. The method of embodiment A10, comprising:
dividing the sequentially arranged 3D points into a plurality of groups of sequentially arranged 3D points; and
assigning each group of sequentially arranged 3D points into the initial sub-slices.

B1. A computer program (1400) comprising instructions (1444) which when executed by processing circuitry (1402) cause the processing circuitry to perform the method of any one of embodiments A1-A11.

B2. A carrier containing the computer program of embodiment B1, wherein the carrier is one of an electronic signal, an optical signal, a radio signal, and a computer readable storage medium.

C1. An apparatus (1400) being configured to:

obtain (s1302) three-dimension, 3D, point data indicating a set of 3D points; determine (s1304) a volume (e.g., left FIG. 3, the cube) containing the set of 3D points;
partition (s1306) the volume into a plurality of slices (e.g., right FIG. 3, the three boxes bounded by dotted lines and the cube at the bottom left), wherein the plurality of slices includes a first slice (e.g., right FIG. 3, the cube at the bottom left);
partition (s1308) the first slice into a plurality of sub-slices (FIG. 8, the bottom left three rectangles bounded by the dotted lines) such that a dimension value of each of the sub-slices is equal to an integer multiple of a size of a node;
partition (s1310) each of the sub-slices into a plurality of nodes; and
for each node, generate (s1312) 3D point data indicating one or more 3D points included in the node.

C2. The apparatus of embodiment C1, wherein the apparatus is configured to perform the method of any one of embodiments A2-A11.

D1. An apparatus (1400) comprising:
a processing circuitry (1402); and
a memory (1441), said memory containing instructions executable by said processing circuitry, whereby the apparatus is operative to perform the method of any one of embodiments A1-A11.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCE LIST

| | |
|---|---|
| 1. | Graziosi, D., Nakagami, O., Kuma, S., Zaghetto, A., Suzuki, T. and Tabatabai, A., |
| | 2020. An overview of ongoing point cloud compression standardization activities: |
| | video-based (V-PCC) and geometry-based (G-PCC). APSIPA Transactions on |
| | Signal and Information Processing, 9(1). |
| 2. | WG 7, MPEG 3D Graphics Coding, 2021, G-PCC codec description. |

1. A method comprising:
obtaining three-dimensional (3D) point data indicating a set of 3D points;
determining a volume containing the set of 3D points;
partitioning the volume into a plurality of slices, wherein the plurality of slices includes a first slice;
partitioning the first slice into a plurality of sub-slices such that a dimension value of each of the sub-slices is equal to an integer multiple of a size of a node;
partitioning each of the sub-slices into a plurality of nodes; and
for each node, generating 3D point data indicating one or more 3D points included in the node.

2. The method of claim 1, wherein each of the nodes is a trisoup node.

3. The method of claim 1, wherein generating the 3D point data indicating the one or more 3D points included in the node comprises:
finding within the node a point surface on which the one or more 3D points are located;
identifying one or more crossing points at which the point surface crosses edges of the node; and
generating cross point data indicating the identified one or more crossing points.

4. The method of claim 1, wherein the method further comprises:
determining a boundary of a first initial sub-slice of the first slice, wherein a dimension value of the first initial sub-slice is not equal to an integer multiple of the size of the node; and
in case the dimension value of the first initial sub-slice is not equal to an integer multiple of the size of the node, adjusting the boundary of the first initial sub-slice such that the dimension value of the first initial sub-slice is equal to an integer multiple of the size of the node, wherein
a boundary of one of the plurality of sub-slices is equal to the adjusted boundary of the first initial sub-slice.

5. The method of claim 4, wherein adjusting the boundary of the first initial sub-slice results in reducing the dimension value of the first initial sub-slice.

6. The method of claim 4, wherein the method further comprises:
calculating a number of a plurality of initial sub-slices of the first slice based on a number of 3D points included in the first slice and a threshold value; and
calculating a number of 3D points included in each of the initial sub-slices (N_{size}) based on the number of 3D points included in the first slice and the calculated number of initial sub-slices, wherein
the number of 3D points included in each of the initial sub-slices is less than or equal to the threshold value, and
the plurality of initial sub-slices includes the first initial sub-slice.

7. The method of claim 6, wherein the method further comprises:
counting a number of 3D points arranged in a particular direction within the first slice; and
stopping the counting when the counted number becomes greater than N_{size}, wherein
the boundary of the first initial sub-slice is determined such that the boundary of the first initial sub-slice is between a location of the last counted 3D point and the second last counted 3D point.

8. The method of claim 7, wherein S_{N}=┌N/Nₜₕ┐, where S_{N} is the number of initial sub-slices, N is the number of 3D points included in the first slice, and Nₜₕ is the threshold value.

9. The method of claim 7, wherein S_{size}=└N/S_{N}┘, where S_{size} is the number of 3D points included in each of the initial sub-slices, N is the number of 3D points included in the first slice, and S_{N} is the number of initial sub-slices.

10. The method of claim 7, wherein
$${S}_{size} = ( ⌊ \frac{N}{{S}_{N}} ⌋ + {N}_{th} ) / 2 ,$$
where S_{size} is the number of 3D points included in each of the initial sub-slices, N is the number of 3D points included in the first slice, S_{N} is the number of initial sub-slices, and Nₜₕ is the threshold value.

11. The method of claim 1 wherein the method further comprises:
determining within the first slice a bounding box bounding all 3D points included in the first slice, wherein the bounding box has a first dimension value associated with a first direction, a second dimension value associated with a second direction, and a third dimension value associated with a third direction, and further wherein the first dimension value is greater than the second dimension value and/or the third dimension value; and
sorting 3D points included the first slice in the first direction such that the 3D points included in the first slice are sequentially arranged with respect to the first direction.

12. The method of claim 11, wherein the method further comprises:
dividing the sequentially arranged 3D points into a plurality of groups of sequentially arranged 3D points; and
assigning each group of sequentially arranged 3D points into the initial sub-slices.

13. A non-transitory computer readable storage medium storing a computer program comprising instructions which when executed by processing circuitry of an apparatus causes the apparatus to perform the method of claim 1.

14-16. (canceled)

17. An apparatus comprising:
a processing circuitry; and
a memory, the memory containing instructions executable by the processing circuitry, wherein the apparatus is operative to perform a method comprising:
obtaining three-dimensional (3D) point data indicating a set of 3D points;
determining a volume containing the set of 3D points;
partitioning the volume into a plurality of slices, wherein the plurality of slices includes a first slice;
partitioning the first slice into a plurality of sub-slices such that a dimension value of each of the sub-slices is equal to an integer multiple of a size of a node;
partitioning each of the sub-slices into a plurality of nodes; and
for each node, generating 3D point data indicating one or more 3D points included in the node.

18. The apparatus of claim 17, wherein generating the 3D point data indicating the one or more 3D points included in the node comprises:
finding within the node a point surface on which the one or more 3D points are located;
identifying one or more crossing points at which the point surface crosses edges of the node; and
generating cross point data indicating the identified one or more crossing points.

19. The apparatus of claim 17, wherein the method further comprises:
determining a boundary of a first initial sub-slice of the first slice, wherein a dimension value of the first initial sub-slice is not equal to an integer multiple of the size of the node; and
in case the dimension value of the first initial sub-slice is not equal to an integer multiple of the size of the node, adjusting the boundary of the first initial sub-slice such that the dimension value of the first initial sub-slice is equal to an integer multiple of the size of the node, wherein
a boundary of one of the plurality of sub-slices is equal to the adjusted boundary of the first initial sub-slice.

20. The apparatus of claim 19, wherein adjusting the boundary of the first initial sub-slice results in reducing the dimension value of the first initial sub-slice.

21. The apparatus of claim 19, wherein the method further comprises:
calculating a number of a plurality of initial sub-slices of the first slice based on a number of 3D points included in the first slice and a threshold value; and
calculating a number of 3D points included in each of the initial sub-slices (N_{size}) based on the number of 3D points included in the first slice and the calculated number of initial sub-slices, wherein
the number of 3D points included in each of the initial sub-slices is less than or equal to the threshold value, and
the plurality of initial sub-slices includes the first initial sub-slice.

22. The apparatus of claim 21, wherein the method further comprises:
counting a number of 3D points arranged in a particular direction within the first slice; and
stopping the counting when the counted number becomes greater than N_{size}, wherein
the boundary of the first initial sub-slice is determined such that the boundary of the first initial sub-slice is between a location of the last counted 3D point and the second last counted 3D point.

23. The apparatus of claim 22, wherein
S_{N}=┌N/Nₜₕ┐, where S_{N} is the number of initial sub-slices, N is the number of 3D points included in the first slice, and Nₜₕ is the threshold value, and
S_{size}=└N/S_{N}┘ or
$${S}_{size} = ( ⌊ \frac{N}{{S}_{N}} ⌋ + {N}_{th} ) / 2 ,$$
where S_{size} is the number of 3D points included in each of the initial sub-slices and N is the threshold value.
